(19) United States
(12) Patent Application Publication
(10) Pub. No.: US 2019/0147408 A1
(43) Pub. Date: May 16, 2019

(54) METHOD AND DEVICES FOR DETERMINING A MEETING POINT OF GEO-LOCATED USERS

(71) Applicant: DVDPERPLAY SA, Paris (FR)

(72) Inventors: Mathieu RENAUD, Bures Sur Yvette (FR); Pierre MOULONGUET, Paris (FR); Ouissam EL JAMGHILL, Ivry Sur Seine (FR)

(21) Appl. No.: 16/242,786

(22) Filed: Jan. 8, 2019

Related U.S. Application Data
(63) Continuation of application No. PCT/IB2017/054148, filed on Jul. 10, 2017.
Application No. PCT/IB2017/054148 is a continuation of application No. PCT/IB2017/054148, filed on Jul. 10, 2017.
Application No. PCT/IB2017/054148 is a continuation of application No. PCT/IB2017/054149, filed on Jul. 10, 2017.

(30) Foreign Application Priority Data
Jul. 8, 2016 (US) 62360022

(51) Int. Cl. G06Q 10/10; H04W 4/021; H04W 4/029; G06F 16/9537; G06Q 10/02; G06F 16/29

(52) U.S. Cl. CPC G06Q 10/1095; H04W 4/021; G06F 16/29; G06F 16/9537; G06Q 10/02; H04W 4/029

(57) ABSTRACT

A method for determining a meeting point location of a plurality of users willing to meet and each having associated thereto a respective user terminal is disclosed.

Each said terminal has a capability of communications with the other user terminals and has a positioning system providing position information of the terminal.

The method comprises the following steps:
(a) obtaining from the plurality of user terminals the position information thereof and constraints,
(b) calculating an appropriate meeting point location based on the user terminal positions and the constraints, and
(c) communicating information about the meeting point location to each one of said terminals.

### FIELD OF INVENTION

The present invention concerns methods and systems involved in facilitating the meeting of persons while they are in variable locations. It aims in particular at enabling holders of smartphones to meet in a convenient and effective manner in such circumstances.

### BACKGROUND OF THE INVENTION

When people want to meet, they usually call or text each other to discuss the best meeting location. Then, they may use positioning systems, such as GPS (acronym for “Global Positioning System”) to easily reach the selected location.

However, some places or zones may be crowded, for example because of a musical or sports event, there may be no known point of interest, for example because the event takes place in a field or on a beach, and the positioning system may have no indication of paths that may be followed, for example because there are no roads. In such cases, people cannot select a place where they could arrive at about the same time and cannot find a way to meet.

Moreover, it may happen that some of the people who have to meet may leave to go to the meeting location earlier than others. In such a case, they will arrive first and have to wait for others, which is not time-efficient.

### OBJECT AND SUMMARY OF THE INVENTION

The present invention aims at providing an improved meeting point location determination.

To this end, the present invention provides according to a first aspect a method for determining a meeting point location of a plurality of users willing to meet and each having associated thereto a respective user terminal, each said terminal having a capability of communications with the other user terminals and having a positioning system providing position information of the terminal, the method comprises the following steps:

(a) obtaining from the plurality of user terminals the position information thereof and constraints,

(b) calculating an appropriate meeting point location based on the user terminal positions and the constraints, and

(c) communicating information about the meeting point location to each one of said terminals.

Preferred but non-limiting aspects of the above method comprise the following additional features, taken individually or in any technically compatible combinations:
said constraints comprise user constraints.
said user constraints comprise time-related constraints.
said time-related for a given user constraints comprise time constraints caused by other meetings.
said other meetings are meetings whose locations are determined by the same method, the method being capable of determining a succession of meeting locations for a given user.
the method further comprises a step of interacting with a user having user constraints so as to release at least part of said user constraints.
the method further comprises a step of interacting with users having no time-related constraints so as to validate the consideration of a time-related constraint of another user.
said user constraints comprise transportation mode constraints.
said user constraints comprise transportation expense constraints.
the method further comprises a step of changing a transportation mode for a given user according to constraints and of booking a corresponding transportation journey.
said constraints comprise meeting-related constraints.
said meeting-related constraints comprise meeting place-related constraints.
said meeting-related constraints comprise meeting duration constraints.
said meeting-related constraints comprise technical constraints.
step (b) is configured to optimize the travelling time to the meeting point location for at least two users.
step (b) is configured to minimize the travelling time to the meeting point location for at least two users.
the method comprises reiterating steps (a) to (c) so as to calculate and communicate a meeting point location capable of changing over time.
the method further comprises a step of determining whether the meeting point location or one of the meeting point locations is near the location of a point of interest and, in the affirmative, changing the meeting point location to the location of said point of interest.
the method further comprises a step of freezing the meeting point location in response to a freezing instruction received on one of said user terminals.
step (b) comprises determining at least one available transportation system that may be used by at least one of the users in order to determine the time spent by said person to reach the meeting point.
the method further comprises a step of providing user a recognition instruction to at least one user terminal pursuant to the determination that the location of said user terminal approaches the meeting point location.
the recognition instruction comprises an instruction to make a sign with his/her body.
the method further comprises a step of displaying, on at least one user terminal, route indications to reach the meeting point location.
step (b) is configured to take into account stored user profile information.
the user profile information comprises an average walking speed of said user.
the user profile information comprises meeting point preferences of said user.
said user terminals comprises a display of a representation of an avatar of a person in a virtual reality representation.
step (b) is performed in a computing system remotely communicating with said user terminals.
step (b) is performed in at least one of said user terminals.
the method further comprises a step of triggering a transaction in response to a relationship between user locations and meeting point location.

According to a second aspect, a system is provided, comprising a plurality of computerized user terminals and a computerized server, further comprising stored computer instructions for performing a method as defined above.

According to a third aspect, the invention provides a computerized user terminal comprising a processor, a memory, a display, a wireless communications channel, and stored instructions for performing terminal-side steps of the method as defined above.

According to a fourth aspect, the invention provides a server comprising a processor, a memory, wireless communications channels, and stored instructions for performing server-side steps of the method as defined above.

The present invention also aims at providing an efficient meeting point location determination taking into account power issues with a user terminal.

To this end, the present invention provides according to a first aspect a method for determining a meeting point location of a plurality of users willing to meet and each having associated thereto a respective user terminal having a capability of communications with the other user terminals and having a positioning system providing position information of the terminal, the method comprises the following steps:

(a) obtaining from the plurality of user terminals the position information thereof,

(b) calculating an appropriate meeting point location based on the user terminal positions,

(c) communicating information about the meeting point to each one of said terminals, and

(d) whenever a predetermined event at a given user terminal occurs, freezing the meeting point location.

Preferred but non-limiting aspects of the above method comprise the following additional features, taken individually or in any technically compatible combinations:
said given user terminal is powered by a respective battery, and said predetermined event is a lack of electrical battery power.
the method further comprises a step of changing the meeting point location to the current position of said given user terminal before freezing the meeting point location.
the method further comprises a step of providing to the user of said given user terminal a message instructing said user to stay at his/her current location.
step (b) is configured to optimize the travelling time to the meeting point location for at least two users.
step (b) is configured to minimize the travelling time to the meeting point location for at least two users.
the method comprises reiterating steps (a) to (c) so as to calculate and communicate a meeting point location capable of changing over time.
the method further comprises a step of determining whether the current meeting point location is near the location of a point of interest and, in the affirmative, changing the meeting point location to the location of said point of interest.
the method further comprise a step of freezing the meeting point location in response to a freezing instruction received on one on said user terminals.
step (b) comprises determining at least one available transportation system that may be used by at least one of the users, to determine the time spent by said person to reach the meeting point.
the method further comprises a step of providing user a recognition instruction to at least one user terminal pursuant to the determination that the location of said user terminal approaches the meeting point location.
the recognition instruction comprises a instruction to make a sign with his/her body.
the method further comprises a step of displaying, on at least one user terminal, route indications to reach the meeting point location.
step (b) is configured to take into account stored user profile information.
the user profile information comprises an average walking speed of said user.
the user profile information comprises meeting point preferences of said user.
said user terminal comprises a display of a representation of an avatar of a person in a virtual reality representation.
step (b) is performed in a computing system remotely communicating with said user terminals.
step (b) is performed in at least one of said user terminals.
the method further comprises a step of triggering a transaction in response to a relationship between user locations and meeting point location.

According to a second aspect, a system is provided, comprising a plurality of computerized user terminals and a computerized server, further comprising stored computer instructions for performing a method as defined above.

According to a third aspect, the invention provides a computerized user terminal comprising a processor, a memory, a display, a wireless communications channel, and stored instructions for performing terminal-side steps of the method as defined above.

According to a fourth aspect, the invention provides a server comprising a processor, a memory, wireless communications channels, and stored instructions for performing server-side steps of the method as defined above.

The present invention also aims at providing an efficient meeting point location determination while allowing such determination to be superseded by users.

To this end, the present invention provides according to a first aspect a method for determining a meeting point location of a plurality of users willing to meet and each having associated thereto a respective user terminal, each said terminal having a touch screen, a capability of communications with the other user terminals and a positioning system providing position information of the terminal, the method comprises the following steps:

(a) obtaining from the plurality of user terminals the position information thereof,

(b) calculating an appropriate meeting point location based on the user terminal positions,

(c) communicating information about the meeting point location to each one of said terminals,

(d) displaying the meeting point location on a map of the touch screen of each user terminal, and

(e) in response to a user action on the touch screen of one of said user terminals, freezing a meeting point location.

Preferred but non-limiting aspects of the above method comprise the following additional features, taken individually or in any technically compatible combinations:
said user action comprises sliding a displayed graphical object representing the meeting point location of said map, the new meeting point location after sliding being frozen.
said user action comprising selecting on said map graphical object representing a point of interest located near the current meeting point location, the meeting point location being changed to the location of said point of interest and frozen there.
step (b) is configured to optimize the travelling time to the meeting point location for at least two users.
step (b) is configured to minimize the travelling time to the meeting point location for at least two users.
the method comprising reiterating steps (a) to (c) so as to calculate and communicate a meeting point location capable of changing over time.
step (b) comprises determining at least one available transportation system that may be used by at least one of the users in order to determine the time spent by said person to reach the meeting point.
the method further comprises a step of providing user a recognition instruction to at least one user terminal pursuant to the determination that the location of said user terminal approaches the meeting point location.
the recognition instruction comprises a instruction to make a sign with his/her body.
the method further comprises a step of displaying, on at least one user terminal, route indications to reach the meeting point location.
step (b) is configured to take into account stored user profile information.
the user profile information comprises an average walking speed of said user.
the user profile information comprises meeting point preferences of said user.
said user terminal is capable of displaying a representation of an avatar of a person in a virtual reality environment.
step (b) is performed in a computing system remotely communicating with said user terminals.
step (b) is performed in at least one of said user terminals.
the method further comprises a step of triggering a transaction in response to a relationship between user locations and meeting point location.
step (a) further comprises obtaining from the plurality of user terminals constraints, and step (b) is further based on said constraints.

According to a second aspect, a system is provided, comprising a plurality of computerized user terminals and a computerized server, further comprising stored computer instructions for performing a method as defined above.

According to a third aspect, the invention provides a computerized user terminal comprising a processor, a memory, a display, a wireless communications channel, and stored instructions for performing terminal-side steps of the method as defined above. According to a fourth aspect, the invention provides a server comprising a processor, a memory, wireless communications channels, and stored instructions for performing server-side steps of the method as defined above.

### BRIEF DESCRIPTION OF THE DRAWINGS

Other advantages, aims and features of the present disclosure will become apparent from the description that will follow, made, as an example that is in no way limiting, with reference to the drawings included in an appendix, in which:

FIG. 1 is a diagrammatic view of devices involved in implementing the method of the present disclosure;

FIG. 2 is a diagrammatic view of a first embodiment of the method of the present disclosure;

FIG. 3 is a diagrammatic view of a second embodiment of the method of the present disclosure;

FIG. 4 is a first diagrammatic view of a screen of a device implementing the method of the present disclosure;

FIG. 5 is a second diagrammatic view of a screen of a device implementing the method of the present disclosure;

FIG. 6 is a third diagrammatic view of a screen of a device implementing the method of the present disclosure;

FIG. 7 is a fourth diagrammatic view of a screen of a device implementing the method of the present disclosure;

FIG. 8 is a fifth diagrammatic view of a screen of a device implementing the method of the present disclosure;

FIG. 9 is a first diagrammatic representation of an implementation of an embodiment of the method of the present disclosure, and

FIG. 10 is a second diagrammatic representation of an implementation of an embodiment of the method of the present disclosure.

### DETAILED DESCRIPTION OF EMBODIMENTS

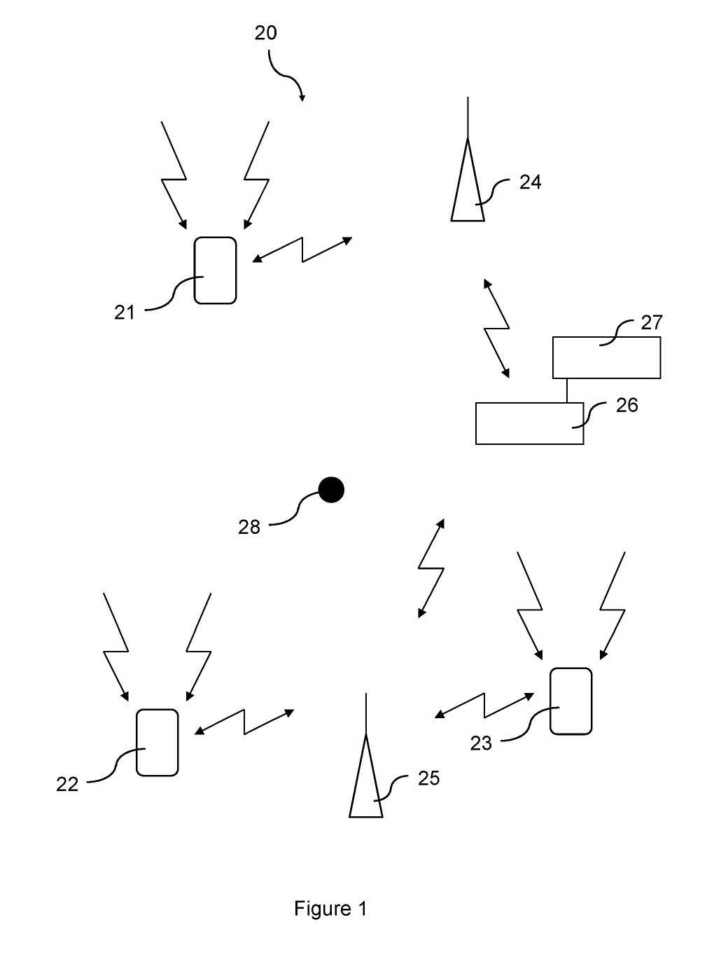

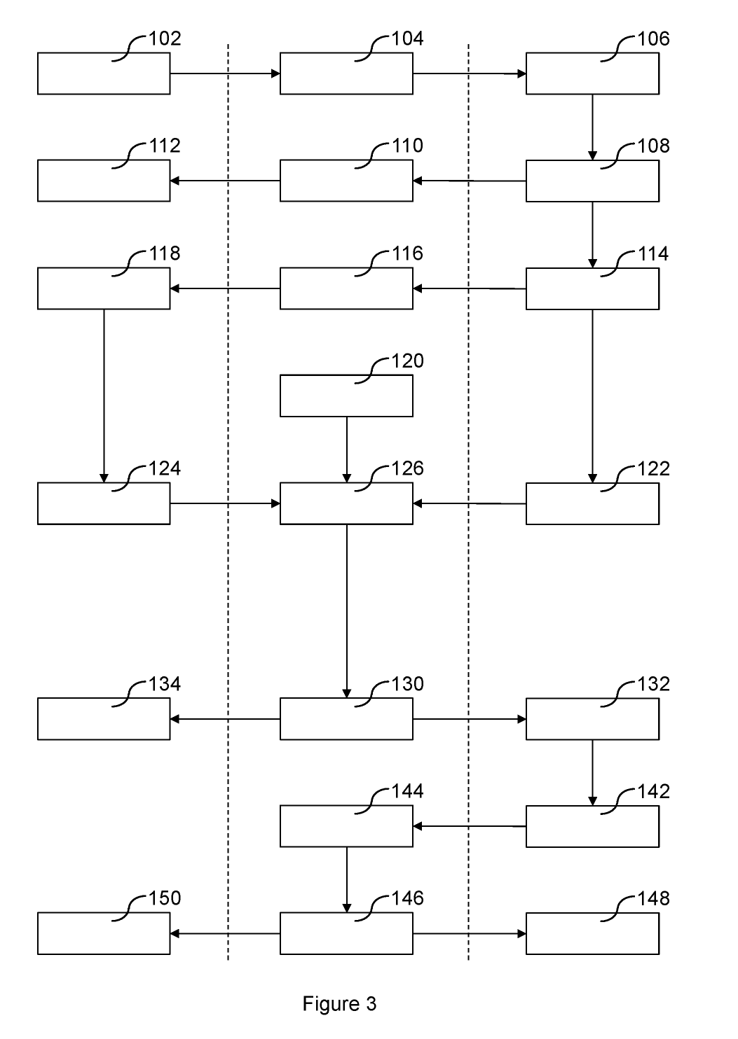

As shown in FIG. 1, a method uses at least two mobile communicating devices. In FIG. 3, three mobile communicating devices 21, 22 and 23. The mobile devices may be smartphones, tablets, or any other kind of connected object. Base stations 24 and 25 enable the mobile devices 21 to 23 to communicate with a remote central processing unit, for example a server, 26. The server 26 also communicates with other servers 27, through the Internet.

Each mobile device 21 to 23 is able to determine its own current position thanks to a positioning system, for example based on satellites emitting synchronized clocks. Each mobile device 21 to 23 sends this current position to the server 26. Moreover, each mobile device 21 to 23 may send to the server 26 user profile information:
an available transportation system, e.g., car, bus, motorcycle, bicycle, boat wherein the user is currently,
user preferences, for example musical bars or quiet places and/or
user attributes, for example maximum or average speed when walking.

The server 26 may request information from other server 27, for example bus time schedule, traffic information, available car sharing services . . . .

Then server 26 calculates, based on at least the positions of persons who are wishing to meet, the meeting point 28 that is a location for which the traveling time is optimized for at least two persons. The server 26 then sends the meeting point coordinates to each one of the mobile devices 21 to 23.

The server 26 may also suggest at least one noticeable meeting point nearby the calculated meeting point, e.g., a store, a restaurant, a bar, a place where the persons have already met, a place that one of the persons appreciates, etc.

The suggested meeting point is calculated based on user profile information such as a previously well-rated place or a type of appreciated place and based on attributes of recognizable points of interests, e.g. type of place, previously-chosen meeting point, sponsored site, event linked to the site such as a temporary discount or a flash sale of concert of cinema tickets.

Alternatively, one of the mobile devices serves as the central processing unit and functions as the server 26 shown in FIG. 1.

Note that, if a person is moving independently from the others, the meeting point will progressively reach that person. If the one of the mobile devices is fixed at a position, for example the home of one of the persons who wish to meet, the others will be guided to meet together and then to meet the person who does not move. Moreover, the person who does not move and its mobile device will receive an estimation of the time left before the moving persons reach them. Accordingly an application running on the non-moving device will be able to launch some processes, such as heating the place, cooking . . . .

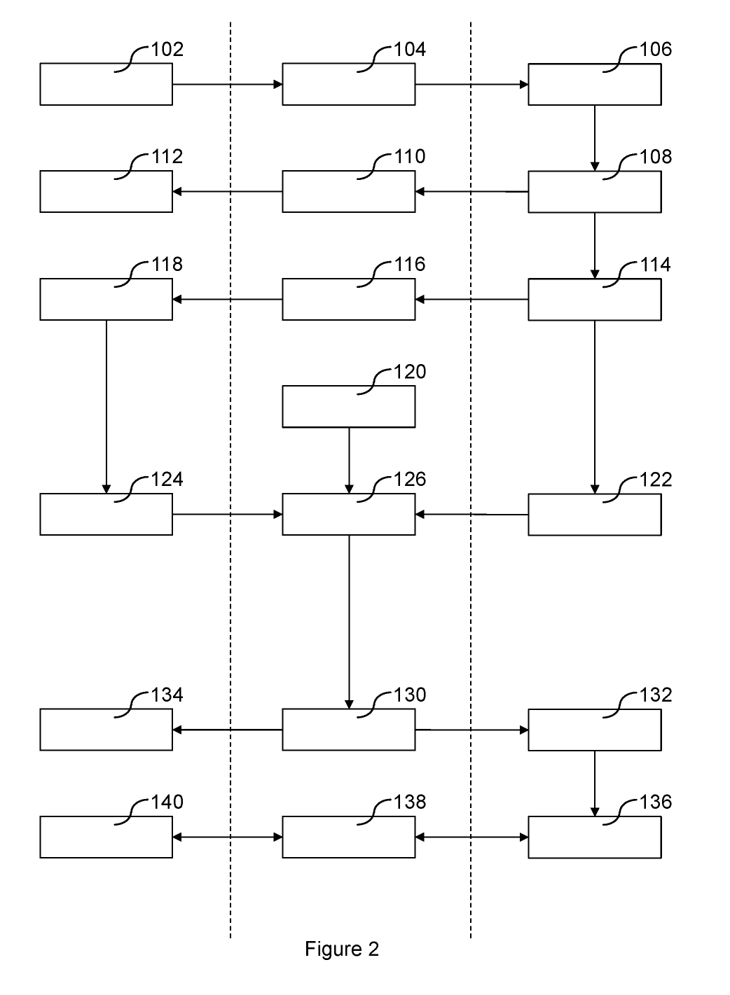

FIG. 2 shows an embodiment of a method according to the present invention wherein the left column represents steps implemented by a mobile device 21 of a first user, the central column represents steps implemented by a server 26 and the right column represents steps implemented by a mobile or fixed device 23 of a second user. In case of a fixed device 23, second user can be the first user. Said device is hereafter referenced as mobile device 23 of the second user.

The embodiments depicted in FIGS. 2 and 3 may be implemented with more than two mobile devices, 21 to 23.

During step 102, the mobile device 21 of the first user communicates with a server 26 and presents a request to obtain the position of the mobile device 23 of the second user. The server 26 transmits said request to the mobile device 23 of the second user during step 104. The mobile device 23 of the second user receives said request during step 106 and transmits an authorization to access the position of the mobile device 23 of the second user by the mobile device 21 of the first user. The authorization is relayed by the server 26, during step 110, to the mobile device 21 of the first user, which receives it during step 112.

Simultaneously to the step of authorization 108, the position of the mobile device 23 of the second user is sent to mobile device 21 of the first user through the server 26. The server 26 transmits said position during step 116, the position being received during step 118 by the mobile device 21 of the first user.

Once the authorization and the position are received by the mobile device 21 of the first user, the mobile device 21 of the first user will transmit the recorded user profile information, preferences and attributes to the server 26 during step 124.

Once the authorization and the position are sent by the mobile device 23 of the second user, the mobile device 23 of the second user will transmit the recorded user profile information, preferences and attributes to the server 26 during step 122.

Upon reception of the information from the mobile devices, 21 and 23, of the first and second user, during step 126, the server calculates and suggests an optimum and pertinent meeting point.

Said meeting point suggestion is sent to both the mobile device 21 of the first user and the mobile device 23 of the second user by server 26 during step 130.

The mobile device 21 of the first user receives the meeting point and initiates a guidance sequence to the meeting point during step 134. The mobile device 23 of the second user receives the meeting point and initiates a guidance sequence to the meeting point during step 132.

Each mobile device, 21 and 23, calculates, in real time, information concerning the travel of the user to the meeting point and sends said information to the server 26, during step 140 regarding the mobile device 21 of the first user, and during step 136 regarding the mobile device 23 of the second user.

The server receives the real time information and transmits, in real time, the information regarding the other mobile device, 21 or 23, to the mobile device of the first or second user, 21 or 23 during step 138.

The real time information calculated is, for example:
an estimated time of arrival (acronym “ETA”),
a traveling speed,
a means of transportation used,
the occurrence of an accident,
a real time localization,
at least one message,
an unforeseen event, or
estimated battery life.

FIG. 3 represents steps 102 to 140 of FIG. 2, and additional steps concerning a predetermined event. In the embodiment pictured in FIG. 3, the predetermined event occurs on the mobile device 23 of the second user, for example, the lack of electrical power of mobile device 23 of the second user.

The information that a predetermined event has occurred is sent by the mobile device 23 of the second user during step 142 to the server 26. The server 26 receives said information during step 144 and recalculates the optimal and pertinent meeting point during step 146. During step 146, the recalculated meeting point is also sent to each mobile device, 21 and 23.

The mobile device 21 of the first user receives the recalculated meeting point and recalculates the guidance sequence during step 150. The mobile device 23 of the second user receives the recalculated meeting point and recalculates the guidance sequence during step 148.

In the example presented above concerning a lack of electrical power of a mobile device 23, the recalculated meeting point becomes the location of the second user. The second user is also informed to stay in place.

In embodiments, the guidance sequence are recalculated to optimize the traveling time including possible detours of one or more users. The detour is made to reach the user for whom the predetermined event has occurred. For example, the duration of a detour and the delay to arrival is calculated for each user other than the user for whom the predetermined event occurred.

The user for whom the delay to arrival is the smallest is detoured and the guidance sequence is recalculated. Also, if the duration of a detour of a first user is superior to the delay to arrival of a second user, the second user will meet the user for whom a predetermined event has occurred. However if the detour of the first user is inferior to the delay to arrival of the second user, the first user should be detoured. A verification of whether the suggested solution is carried out. If not, both user meet the user for whom the predetermined event has occurred.

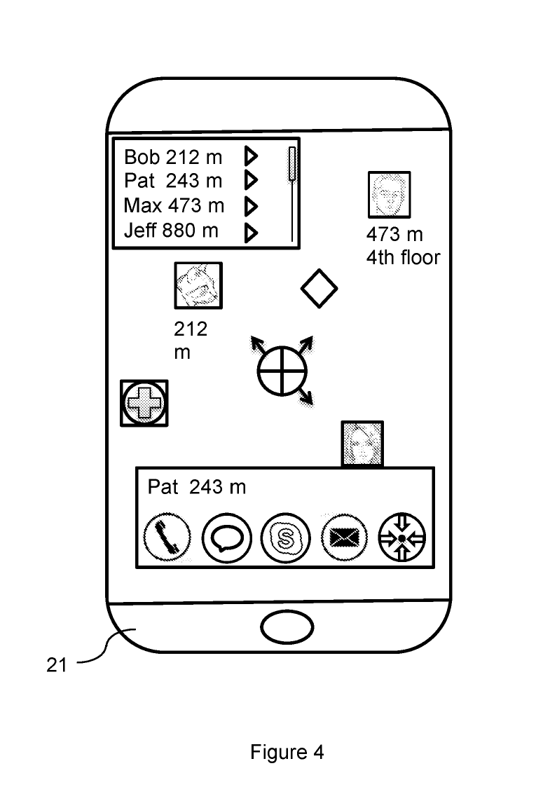

FIGS. 4 to 7 represent diagrammatic views of a screen of a device implementing the method of the present invention.

As shown in FIG. 4, the topography of the location of the user is a representation of geo-localized places surrounding the user, such as a pharmacy, for example.

A list of the other users, part of a group wishing to meet, is accessible by the user. The selection of a user in said list enables the user to choose an action regarding the selected user among a predefined list of actions. The name of each user is indicated next to each user of the group. The other users part of the group are represented by their avatars and/or their pseudonyms. The position of each avatar on the topography corresponds to the physical localization of the user represented by said avatar. An indication of the distance of each user is joined to the avatar representing said user. In case of different altitudes, a number of floors is calculated based on information from an altimeter of the mobile device of the user. The topography may be changed by a user between predefined maps such as a city map, a compass or a bus map, for example.

An icon, such as a diamond in the present example, represents the center of gravity of the users of the group. If activated by the user, through an action named “meet me” for example, said center of gravity is the meeting point of the group. If frozen by the user, the position of the diamond is frozen and the frozen location becomes the meeting point of the group.

The user is represented by an icon in the shape of a target in the center of the screen. A pointer points to the direction in which a site or a user part of the group is physically located. The orientation of the pointers on the screen depend on the physical orientation of the mobile device of the represented user. The physical orientation is obtained through, a compass of the positioning system, for example.

Other avatars may be represented such as firefighters, first-aid workers or animations. The visibility of such avatars depends on a filter set by the user of the mobile device.

The display may comprise different icons representing predefined actions, for example located at the bottom of the screen of a mobile device. The predefined actions can be the initiation of a telephone conversation, the expedition of a text message, a connection to a social media network, and/or the “meet me” action.

Groups may be defined by the user through a contact list. The contact list may be extracted from a preexisting contact list stored on the mobile device. If the screen is a touchscreen, the user may zoom in or out on the represented topography by approaching or separating two fingers touching the screen.

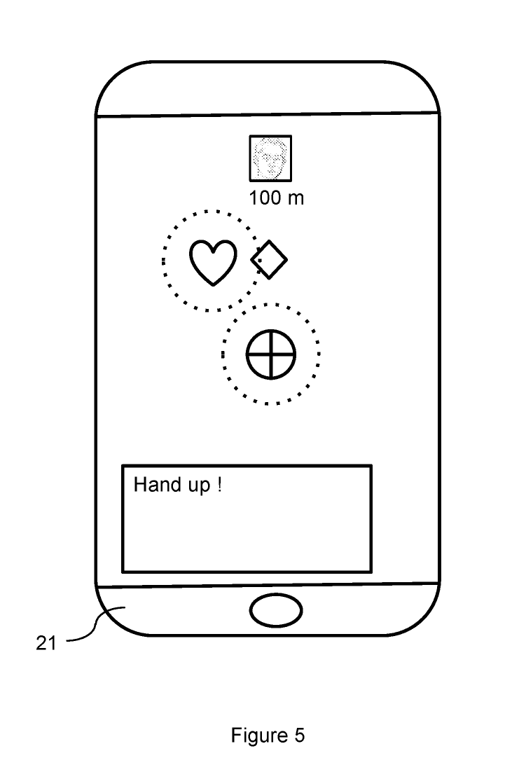

As shown in FIG. 5, the meeting point is mobile when calculated and updated in real time, for example when two users, part of the same group, are heading towards each other. When the meeting point is frozen, the meeting point corresponds to a recognizable point of interest, or a user has frozen said point by lack of electrical power. The action of freezing a meeting point is named “meet me there”, for example.

The point of interest may be a communication appliance comprising connections means to a network.

When the distance between two users is inferior to a predefined distance, such as one hundred meters, and when the mobile devices are oriented towards each other, a signal to make a sign with their body is displayed to the users. When the mobile devices are oriented towards each other, the avatar of the other user will be positioned at the top of the screen. An example of signal is “Hand up!”. In particular embodiments, when the signal is displayed a flash of the mobile device starts a predetermined sequence.

However, in the same conditions and if one of the device has low electrical power, a message to halt is displayed on the screen of the device with low electrical power. The message may be “Halt”. The last known location of the mobile device with low electrical power becomes the meeting point. The other mobile devices may display a message to indicate that a friend is at said meeting point such as “The batteries of user A have run out. He/She is waiting for you.”.

If a meeting point is located in a geo-fence of a sponsored site, promotional messages may be sent to the users of a group such as “Beginning of the animation in ten minutes”. As a reminder a geo-fence is a virtual perimeter for a real-world geographic area.

When two users or recognizable points of interests are located at a distance inferior to a predefined distance, a predefined action may be triggered, such as:
displaying the message “Hand up”, when the distance is shorter than one hundred meters;
displaying the message “Head up”, when the distance is shorter than twenty meters;
displaying an advertisement, when the distance between ad user and a recognizable point of interest is inferior to the predefined distance;
displaying a guidance message, such as “your station of destination is in two stops”; or
the start of an electrical appliance or house equipment, such as an oven or a central heating system, when the user, owner or user of a location, arrives at destination.

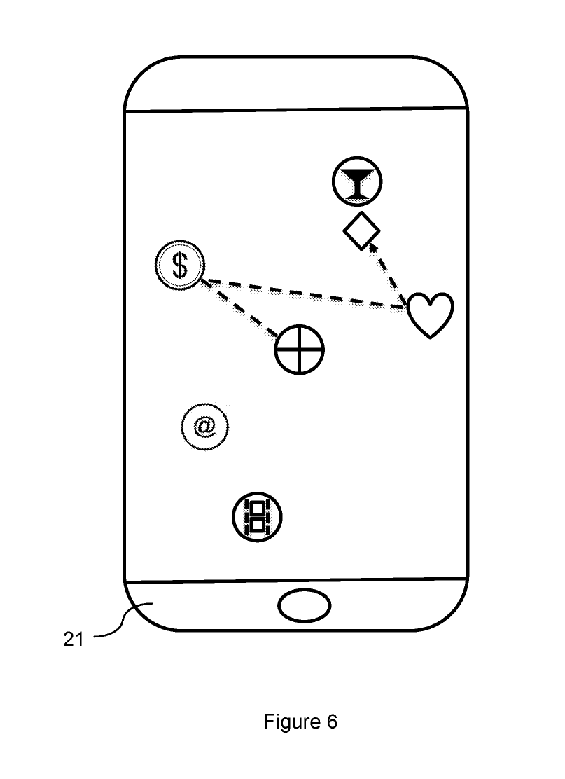

As shown in FIG. 6, permanent fixed sites are for example a bank, a bar, a hotspot, a cinema or a tent. A hotspot is a signaled point of access to a wireless local area network. A permanent fixed site is a recognizable point of interest. A user can approach a permanent fixed site and declare it, for example through a name, a category, comments, or a star rating, and sponsor it buy paying a fee in order to highlight the site. Said permanent fixed site is geo-localized by the mobile device of the declaring user.

Each recognizable point of interest is defined by:
identifiers comprising a name and a category e.g. restaurant, shop, concert hall . . .
attributes comprising an average rating and comments,
sponsored events e.g. flash sales or temporary discounts . . .

The permanent fixed site appears on different topographies according to filters set by users, a selected sponsoring program and a rating of the permanent fixed site. The rating may depend on a number of average stars chosen by users, the number of choosing users and the number of comments. A star is a rating example.

According to the permanent fixed site's category, any user may comment or rate the permanent fixed site or modify attributes, such as empty site, toilet unavailable, beginning of a show, for example.

The meeting point is by default calculated as the center of gravity of users of a group. The meeting point may be modified to a permanent fixed site depending on the rating and the attributes of the permanent fixed site, and on the users' preferences, attributes and profile information.

In embodiments, the meeting point is defined according to a traveling time, wherein transport is assured by various transportations systems such as a guidance sequence comprising walking, riding a bike and riding the bus.

In embodiments, the meeting point is defined by user preferences, recorded in the user profile information, relative to the optimization criteria such as:

approaching the geometrical center of gravity of the departure points of each user of the same group;

approaching the geometrical center of gravity of the real-time location of each user of the same group;

equalizing the traveling time for each user of the same group;

minimizing the sum of the individual traveling times;

minimizing the carbon footprint of each user of the same group;

minimizing the sum of the transportation expenses; and/or

including in the sum of the predictable traveling times and/or distances, including the following destination of a user after a first meeting.

In embodiments, the meeting point is modified by the collaboration of the users of a group according the following method:
calculating a meeting zone surrounding the meeting point according to an average of meeting zones predefined by the users of a group, said zone comprising an arranged list of recognizable points of interest;
requesting the selection of each user of the group, through the display of a message, within the arranged list of recognizable points of interest, more specifically when a conflict is detected between user preferences;
selecting a definitive meeting point.

The step of selecting a final meeting point may be arbitrated by the user organizing the meeting or by a vote. The selection of a definitive meeting point may trigger a reservation e.g. of movie theater tickets or a table at a restaurant.

Temporary fixed sites may be defined, such as food trucks, street performers, or fireworks. A temporary fixed site is a recognizable point of interest. The temporary fixed sites are declared by a user, similarly as for a permanent fixed site, but for a predefined duration. The user also declares the predefined duration.

In certain embodiments, the predefined duration of a temporary fixed site is modified by other users traveling close to the location of the temporary fixed site through a declaration of modification or end, for example, a street event is still in place or has ended.

A guidance sequence may be calculated according to a predefined sequence of selected fixed sites. Once calculated, the screen displays said guiding sequence. The display of the guiding sequence may be oriented taking into account the orientation of the mobile device of the user, for example, the maps pivots when the mobile device pivots to correspond to the surroundings of the user.

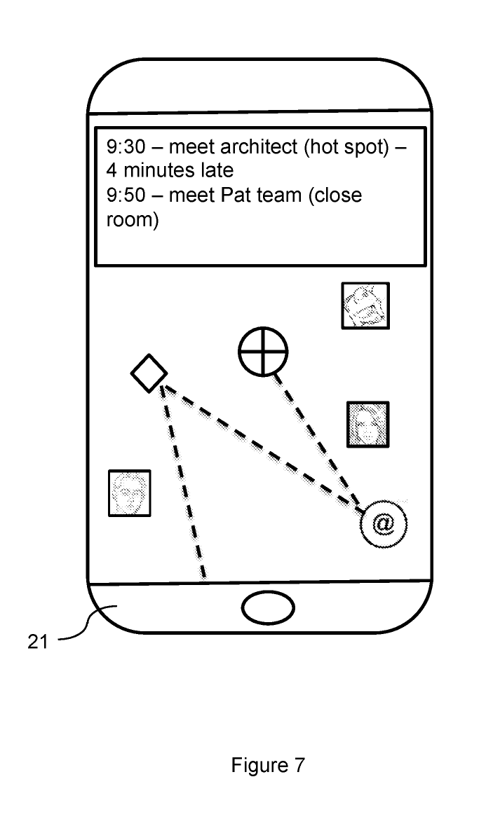

As shown in FIG. 7, an agenda can be defined by meeting points and groups. The meeting points may be frozen or defined as center of gravity. The meeting point may be defined taking into account technical constraints such as the access to a closed office, a hotspot, electricity or a safe site.

The guiding sequence is calculated as a function of set meeting times, the meeting points, and the constraints for each meeting entered in the agenda. The constraints for each meeting comprise the duration of the meeting, the earliest possible beginning time and the latest possible end time, the maximum length of the reserved time in the agenda and the traveling time.

In certain embodiments, each user arbitrates conflicts in agendas with warning messages and agenda edition means. A user may offer alternatives or arbitrate the time affected to each activity by modifying the constraints.

The user preferences comprise a time margin in order to define a meeting point taking into account the constraints of each user. In case the time margin of one of the users is exceeded, messages are sent to the other users participating in the meeting for whom the travelling time has been extended to obtain their agreement.

For example, two users receive the message: “User A has to return to his office by five P.M. Do you accept to extend your travelling time to preserve a meeting of one hour and a half?”

In certain embodiments, user preferences comprise other calculation factors for the meeting point e.g. minimizing the price or carbon footprint of at least one transportation system.

The portions of the trajectory that have a strong probability of delay are configured to blink or glow. A meeting point may be set in advance and shared to the members of the group participating in the meeting. The geo-localization of the members of the group is programmed and occasional in order to save the electrical power of the mobile devices of the users of the group.

In certain embodiments, the meeting point is defined according to a traveling time, wherein transport is assured by various transportations systems such as a guidance sequence comprising walking, riding a bike and riding the bus. In the event of probable delay for a user, a message may put forward an alternate itinerary using a faster transportation system, for which the constraints on travel expenses are ignored. When the user validates the alternate itinerary and the transportation system associated, the transportation system can be booked, such as a train or carpooling reservation.

The constraints take into account the following appointments in the agenda and the location of said appointments. However, the mobile device may suggest to a user participating in the meeting to loosen some constraints in order to facilitate a meeting for at least one other user. For example, the message displayed could be: “Bob has an imperative meeting at two P.M. Do you agree to have travel ten more minutes than him?”

In case no meeting point fits the constraints of the entire group of users participating in a meeting, a user can request an arbitration by the organizer of the meeting. For example, through a meeting point edition interface after visualizing different travel times for each user, the price of the trajectory for each user, the trajectory intersections, the constraints. The meeting point edition interface comprises a travel time control interface and a manual meeting point shifting interface, for example by sliding a finger on a representation of a pin on a screen.

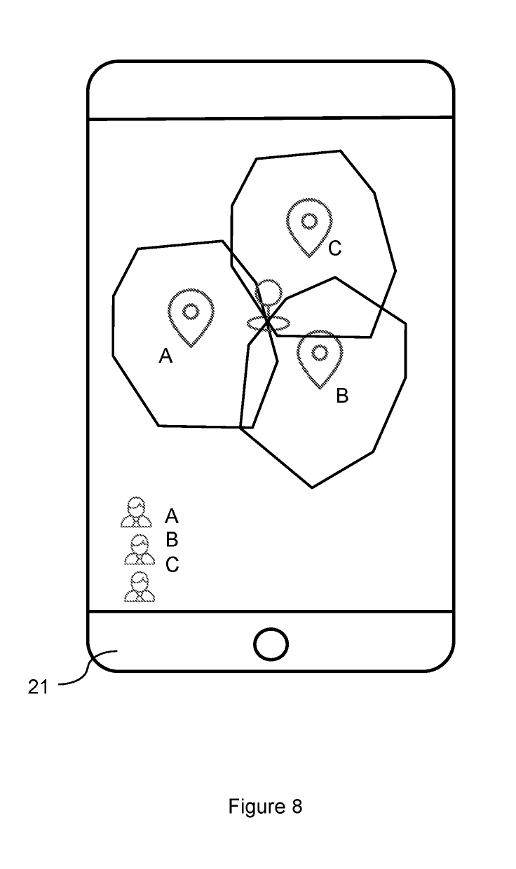

As shown in FIG. 8, the method displays the zones a user can reach for a meeting according to the constraints set for said meeting. Each user is allocated a zone, a meeting point is selected at the intersection of each zone. A user modifies the shape of the allocated zone by modifying user preferences such as available transportation systems. A user modifies the size of a zone by loosening or tightening constraints set for a meeting.

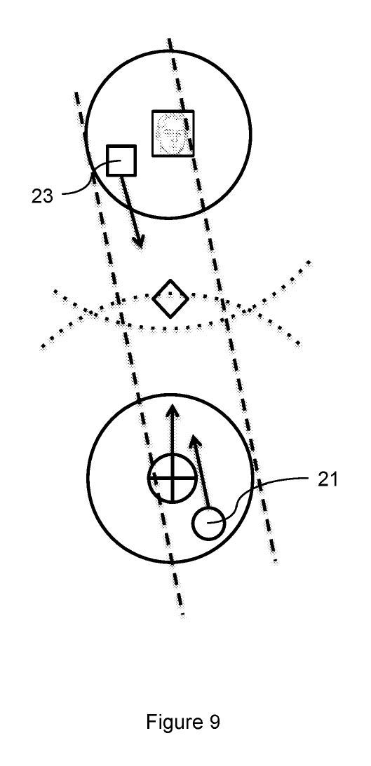

As shown in FIG. 9, the position of a GPS of a mobile device has three dimensional coordinates, each coordinate having a degree of uncertainty. The circle represented around the avatar of each user represents the projection of the sphere representing the degree of uncertainty on a two dimensional plane. The physical position may differ from the represented position.

The meeting points are calculated as being the average of the positions of each user, without weighting, if the landscape, transportation system and travelling speed are not taken into account. The vector of movement between two GPS systems of the mobile device are oriented towards the meeting point. When two users are less than a predefined distance, such as one hundred meters, away from each other, a signal to make a sign with their body is displayed to the users, such as described above.

After a sign has been carried out, the users change their direction. The degrees of uncertainty are then diminished, the new estimation of the locations of the users are transmitted to a server 26 on a network. The meeting point is relocated according to the sharper determination of locations.

In FIG. 9, the real physical position of a user is at the intersection of the circle centered on the avatar of the user and the space defined between the doted lines.

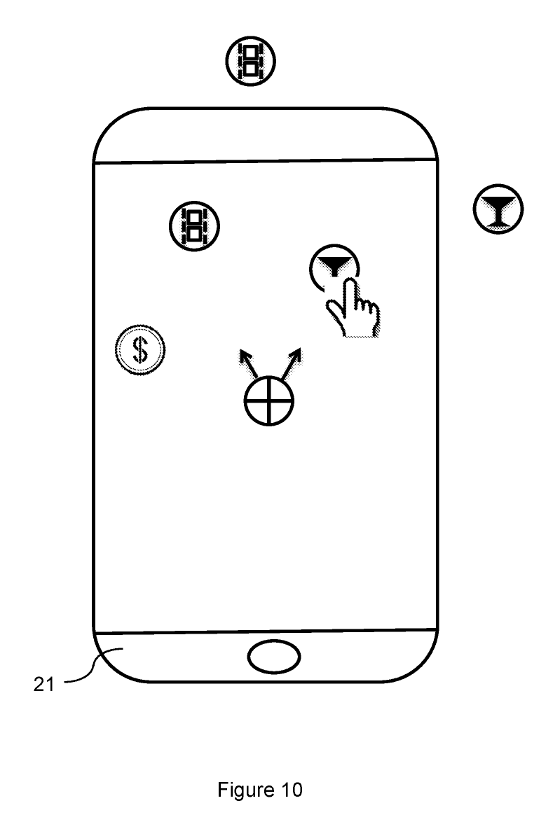

As shown in FIG. 10, physical permanent fixed sites for which the geo-localization is certain are represented on the screen of a user according to the filters set. Because of the degree of uncertainty of the GPS system of the mobile device of the user, the representation of said physical permanent sites are an approximation. The user can set the location of the representations of such physical permanent fixed sites to recalibrate the geo-positioning system and reduce the degree of uncertainty.

In other embodiments, the return trajectory is memorized. For example, in case of parking, the location of parking is memorized.

In other embodiments, the mobile device is set in an energy saving mode, wherein the electrical power of an electronic device is saved, when the mobile device detects that the user is in a public transport, such as a bus. The energy saving mode is deactivated when arriving at a predefined distance from a recognizable point of interest.

In other embodiments, the screen of the mobile device displays a representation of an avatar of a user in a virtual reality representation. The other avatars detailed before may also be represented in the virtual reality representation depending on filters applied by the user.

The present disclosure further comprises the following aspects, taken individually or in any technically compatible combinations:
a method for determining a meeting point, which comprises the following steps:
obtaining from user terminals positions of associated users who are willing to meet,
calculating an appropriate meeting point based on the user terminal positions, and
communicating information about the meeting point to each one of said terminals.
the meeting point is a location for which the traveling time is optimized for at least two users.
the meeting point is a location for which the traveling time is minimized and the same for at least two persons.
a method including reiterating the steps of obtaining the positions, the step of calculating and the step of communicating.
during the step of calculating the meeting point, the calculation of the meeting point so that the traveling times for at least three persons to reach the meeting point are optimized.
a method comprising the following steps:
obtaining from user terminals user information concerning users who are willing to meet,
calculating a potentially variable meeting point from said user information,
communicating information about the meeting point to each one of said terminals, and
freezing the meeting point location whenever a predetermined event takes place.
a method wherein the predetermined event is a lack of electrical power in a terminal used by one of the persons to communicate with the central processing unit, the frozen meeting point then being the position where said terminal is at the time the predetermined event occurs.
a method wherein the predetermined event is a determination that the meeting point is near a point of interest, the frozen meeting point then being said point of interest.
as a predetermined event, an instruction to freeze the meeting point given by a user involved in the meeting.
a step of calculating the meeting point, comprising determining at least one available transportation system that may be used by at least one person wishing to meet, to determine the time spent by said person to reach the meeting point.
a method comprising requesting information from a server to determine each one of said at least one available transportation system.
a method for determining a meeting point, which comprises the following steps:
obtaining from user terminals user information concerning users who are willing to meet,
calculating a meeting point from said user information,
communicating information about the meeting point to each one of said terminals, and
providing user recognition instructions to at least one user terminal when approaching the meeting point.
a method where the instruction is a request that the users makes a sign with their body when the distance between them is shorter than a predetermined distance.
a method that comprises displaying, on a user terminal, route indications to reach the meeting point.
a method for determining a meeting point, which comprises the following steps:
obtaining from user terminals user information comprising user profile information concerning users who are willing to meet,
calculating a meeting point taking into account user profile information, and
communicating information about the meeting point to each one of said terminals.
a method wherein the user profile information comprises an average walking speed.
a method wherein the profile information comprises meeting point preferences.
a method wherein the screen of the mobile device displays a representation of an avatar of a person in a virtual reality representation.
a method wherein the calculation is performed in a system in remote communications with the terminals.
a method wherein the calculation is performed in one or more of the terminals.
a method further comprising the triggering of a connected device in response to a relationship between user location and meeting point location.
a client/server system comprising processing and storage means, a display, wireless communications channels for performing a method as defined above.
a computerized terminal comprising a processor, a memory, a display, a wireless communications channel for performing the terminal-side steps of a method as defined above.
a server comprising a processor, a memory, wireless communications channels for performing the server-side steps of a method as defined above.
a method with user terminals having a positioning system and communicating with each other, wherein a visually identifiable fixed or temporary site can be added by a user terminal for a map, an indication of said site being added to the maps of other user terminals.
a method with user terminals having a positioning system and communicating with each other, wherein the location of a visually identifiable fixed site on the display of a given user terminal can be set so as to recalibrate the positioning system thereof.

1. A method for determining a meeting point location of a plurality of users willing to meet and each having associated thereto a respective user terminal, each said terminal having a capability of communications with the other user terminals and having a positioning system providing position information of the terminal, the method comprises the following steps:
(a) obtaining from the plurality of user terminals the position information thereof and constraints,
(b) calculating an appropriate meeting point location based on the user terminal positions and the constraints, and
(c) communicating information about the meeting point location to each one of said terminals.

2. A method according to claim 1, wherein said constraints comprise user constraints.

3. A method according to claim 2, wherein said user constraints comprise time-related constraints.

4. A method according to claim 3, wherein said time-related for a given user constraints comprise time constraints caused by other meetings.

5. A method according to claim 4, wherein said other meetings are meetings whose locations are determined by the same method, the method being capable of determining a succession of meeting locations for a given user.

6. A method according to claim 4, comprising a step of interacting with a user having user constraints so as to release at least part of said user constraints.

7. A method according to claim 3, comprising a step of interacting with users having no time-related constraints so as to validate the consideration of a time-related constraint of another user.

8. A method according to claim 2, wherein said user constraints comprise transportation mode constraints.

9. A method according to claim 2, wherein said user constraints comprise transportation expense constraints.

10. A method according to claim 8, comprising a step of changing a transportation mode for a given user according to constraints and of booking a corresponding transportation journey.

11. A method according to claim 1, wherein said constraints comprise meeting-related constraints.

12. A method according to claim 11, wherein said meeting-related constraints comprise meeting place-related constraints.

13. A method according to claim 9, wherein said meeting-related constraints comprise meeting duration constraints.

14. A method according to claim 12, wherein said meeting-related constraints comprise technical constraints.

15. A method according to claim 1, wherein step (b) is configured to optimize the travelling time to the meeting point location for at least two users.

16. A method according to claim 1, wherein step (b) is configured to minimize the travelling time to the meeting point location for at least two users.

17. A method according to claim 1, comprising reiterating steps (a) to (c) so as to calculate and communicate a meeting point location capable of changing over time.

18. A method according to claim 1, further comprising a step of determining whether the meeting point location or one of the meeting point locations is near the location of a point of interest and, in the affirmative, changing the meeting point location to the location of said point of interest.

19. A method according to claim 1, further comprising a step of freezing the meeting point location in response to a freezing instruction received on one of said user terminals.

20. A method according to claim 1, wherein step (b) comprises determining at least one available transportation system that may be used by at least one of the users in order to determine the time spent by said person to reach the meeting point.

21. A method according to claim 1, further comprising a step of providing user a recognition instruction to at least one user terminal pursuant to the determination that the location of said user terminal approaches the meeting point location.

22. A method according to claim 21, wherein the recognition instruction comprises an instruction to make a sign with his/her body.

23. A method according to claim 1, further comprising a step of displaying, on at least one user terminal, route indications to reach the meeting point location.

24. A method according to claim 1, wherein step (b) is configured to take into account stored user profile information.

25. A method according to claim 24, wherein the user profile information comprises an average walking speed of said user.

26. A method according to claim 25, wherein the user profile information comprises meeting point preferences of said user.

27. A method according to claim 1, wherein said user terminal comprises a display of a representation of an avatar of a person in a virtual reality representation.

28. A method according to claim 1, wherein step (b) is performed in a computing system remotely communicating with said user terminals.

29. A method according to claim 1, wherein step (b) is performed in at least one of said user terminals.

30. A method according to claim 1, further comprising a step of triggering a transaction in response to a relationship between user locations and meeting point location.

31. A system comprising a plurality of computerized user terminals and a computerized server, further comprising stored computer instructions for performing a method according to claim 1.

32. A computerized user terminal comprising a processor, a memory, a display, a wireless communications channel, and stored instructions for performing terminal-side steps of the method according to claim 1.

33. A server comprising a processor, a memory, wireless communications channels, and stored instructions for performing server-side steps of the method according to claim 1.

34. A method for determining a meeting point location of a plurality of users willing to meet and each having associated thereto a respective user terminal having a capability of communications with the other user terminals and having a positioning system providing position information of the terminal, the method comprises the following steps:
(a) obtaining from the plurality of user terminals the position information thereof,
(b) calculating an appropriate meeting point location based on the user terminal positions,
(c) communicating information about the meeting point to each one of said terminals, and
(d) whenever a predetermined event at a given user terminal occurs, freezing the meeting point location.

35. A method according to claim 34, wherein each said given user terminal is powered by a respective battery, and said predetermined event is a lack of electrical battery power.

36. A method according to claim 34, further comprising a step of changing the meeting point location to the current position of said given user terminal before freezing the meeting point location.

37. A method according to claim 34, further comprising a step of providing to the user of said given user terminal a message instructing said user to stay at his/her current location.

38.-56. (canceled)

57. A method for determining a meeting point location of a plurality of users willing to meet and each having associated thereto a respective user terminal, each said terminal having a touch screen, a capability of communications with the other user terminals and a positioning system providing position information of the terminal, the method comprises the following steps:
(a) obtaining from the plurality of user terminals the position information thereof,
(b) calculating an appropriate meeting point location based on the user terminal positions,
(c) communicating information about the meeting point location to each one of said terminals,
(d) displaying the meeting point location on a map of the touch screen of each user terminal, and
(e) in response to a user action on the touch screen of one of said user terminals, freezing a meeting point location.

58. A method according to claim 57, wherein said user action comprises sliding a displayed graphical object representing the meeting point location of said map, the new meeting point location after sliding being frozen.

59. A method according to claim 57, wherein said user action comprising selecting on said map graphical object representing a point of interest located near the current meeting point location, the meeting point location being changed to the location of said point of interest and frozen there.

60.-77. (canceled)
